(19) United States
(12) Patent Application Publication
(10) Pub. No.: US 2025/0117088 A1
(43) Pub. Date: Apr. 10, 2025

(54) FLUIDICALLY PROGRAMMED WEARABLE HAPTIC DEVICES

(71) Applicant: William Marsh Rice University, Houston, TX (US)

(72) Inventors: Barclay Jumet, Houston, TX (US); Zane Anthony Zook, Houston, TX (US); Anas Nafees Yousaf, Houston, TX (US); Anoop Rajappan, Houston, TX (US); Doris Xu, Houston, TX (US); Te Faye Yap, Houston, TX (US); Nathaniel Wallace Fino, Houston, TX (US); Zhen Liu, Houston, TX (US); Marcia K. O'Malley, Houston, TX (US); Daniel J. Preston, Houston, TX (US)

(73) Assignee: William Marsh Rice University, Houston, TX (US)

(21) Appl. No.: 18/905,992

(22) Filed: Oct. 3, 2024

Related U.S. Application Data
(60) Provisional application No. 63/588,523, filed on Oct. 6, 2023.

(51) Int. Cl. G06F 3/01; G01C 21/36; G06F 1/16; H04W 4/029

(52) U.S. Cl. CPC G06F 3/016; G01C 21/3652; G06F 1/163; H04W 4/029

(57) ABSTRACT

A wearable haptic device and system for providing spatiotemporal cues are disclosed. The system includes a wearable haptic device and a controller. The wearable haptic device includes a fluidic circuit having, at least one fluidic capacitor, wherein each of the at least one fluidic capacitor comprises an inflatable cell formed from a portion of a first material sheet bonded to a portion of a second material sheet to form a hermetic bond, at least one channel fluidically connected to the fluidic capacitor, each of the at least one channel is configured to convey a pressurized fluid to the at least one fluidic capacitor, a master valve, fluidically connected to the at least one channel, and a fluid source fluidically connected to the at least one fluidic capacitor via the at least one channel. The controller sends and receives signals to deliver pressurized fluid to the at least one fluidic capacitor.

### CROSS REFERENCE TO RELATED APPLICATIONS

This application claims priority to U.S. Provisional Application Ser. No. 63/588,523, filed Oct. 6, 2023, entitled, “Fluidically programmed wearable haptic textiles,” which is hereby incorporated by reference.

### STATEMENT REGARDING FEDERALLY SPONSORED RESEARCH

This invention was made with government support under Grant Nos. 2144809, 1830146, and 1842494 awarded by the National Science Foundation. The government has certain rights in the invention.

### BACKGROUND

Haptic stimulation and feedback offer a useful mode of communication in visually or auditorily noisy environments, or in environments where stealth has a high premium. The adoption of haptic devices in our everyday lives, however, remains limited, largely due to a lack of wearability in most haptic devices. The preexisting state of the art is primarily relegated to handheld devices, phones, and wrist-worn smart watches. Even when haptic devices are integrated into clothing, the haptic stimulation tends to rely on non-washable, rigid components that are sewn into or placed into pockets on the clothing. Among the limited exceptions are suits with conductive fabric and gloves with fluidic actuation, both of which still rely on electronic actuators and control schemes which can restrict the wearer's movements. Wearable haptic devices that overcome the limitations of currently available technology would constitute as significant improvement and deliver an enhanced range of practical applications.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a wearable haptic device including a fluidic circuit having at least one fluidic capacitor, and at least one channel fluidically connected to the at least one fluidic capacitor. Each of the at least one fluidic capacitor comprises an inflatable cell formed from a portion of a first material sheet bonded to a portion of a second material sheet to form a hermetic bond, and each of the at least one channel is configured to convey a pressurized fluid to the at least one fluidic capacitor.

In general, in one aspect, embodiments relate to a system for providing spatiotemporal cues, including a wearable haptic device and a controller. The wearable haptic device includes a fluidic circuit having at least one fluidic capacitor, where each of the at least one fluidic capacitor including an inflatable cell formed from a portion of a first material sheet bonded to a portion of a second material sheet to form a hermetic bond, and at least one channel fluidically connected to the fluidic capacitor, each of the at least one channel is configured to convey a pressurized fluid to the at least one fluidic capacitor. Furthermore, the wearable haptic device includes a master valve, fluidically connected to the at least one channel, and a fluid source fluidically connected to the at least one fluidic capacitor via the at least one channel. The controller is configured to send and receive signals to deliver a pressurized fluid to the at least one fluidic capacitor.

In general, in one aspect, embodiments relate to a method of providing spatiotemporal cues, the method including, iteratively, until a stopping condition is met, determining a state of a subject wearing a wearable haptic device providing a signal to a controller configured to control the wearable haptic device, and with the controller, switching on at least one valve to provide a pressurized fluid to at least one inflatable cell whereby the at least one inflatable cell is inflated, providing a force to a skin surface of the subject.

It is intended that the subject matter of any of the embodiments described herein may be combined with other embodiments described separately, except where otherwise contradictory.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency. The advantages and features of the present invention will become better understood with reference to the following more detailed description taken in conjunction with the accompanying drawings in which:

FIGS. 1A-1C show several embodiments of wearable haptic devices;

FIG. 2A depicts variations in temporal control in accordance with one or more embodiments;

FIG. 2B depicts variations in amplitude control in accordance with one or more embodiments;

FIGS. 3A-3D depicts variations in spatial and temporal control implemented within an illustrative embodiment of a wearable haptic device in which spatiotemporal variations in pressure indicate directionality;

FIG. 4 shows a wearable haptic wristband in accordance with one or more embodiments;

FIG. 5 shows side views of an inflatable cell when inflated and uninflated in accordance with one or more embodiments;

FIG. 6A depicts an embodiment of a fluidic resistor;

FIG. 6B shows data recorded from the fluidic resistor depicted in FIG. 6A in accordance with one or more embodiments;

FIG. 7 shows a multi-capacitor, multi-resistor wearable haptic device in accordance with one or more embodiments;

FIGS. 8A-8C show force and pressure responses of wearable haptic devices with capacitors of various sizes in accordance with one or more embodiments;

FIGS. 9A-9D show valve-based and fluidic circuits and characteristics in accordance with one or more embodiments;

FIG. 10 depicts a flowchart in accordance with one or more embodiments;

FIGS. 11A and 11B show from before and after a cycle of multiple washing of an embodiment of a wearable haptic device;

FIGS. 12A and 12B display a wearable haptic sleeve together with data showing the effectiveness of its use;

FIG. 13 is an example of navigation within a field performed using a wearable haptic device;

FIGS. 14A-14 C show a haptic navigation device and its use in navigating city streets.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

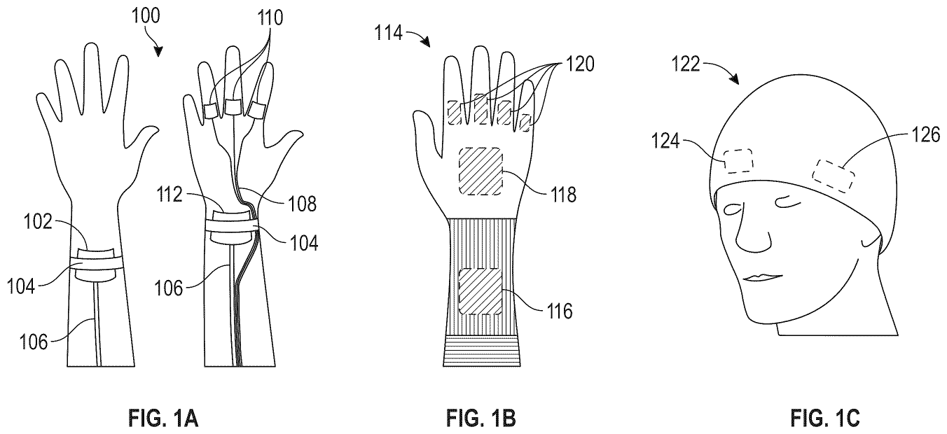

In the following description of FIGS. 1A-14C, any component described regarding a figure, in various embodiments disclosed herein, may be equivalent to one or more like-named components described with regard to any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

It is to be understood that the singular forms “a,” “an,” and “the” include plural referents unless the context clearly dictates otherwise. Thus, for example, reference to “a traveltime” includes reference to one or more of such traveltimes.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Wearables can be used as a platform to integrate haptic cues into our daily lives, much in the same way a smart phone and smart watch have become ubiquitous objects with which we interact and receive haptic cues (e.g., vibrations). There are large markets for wearable haptic devices in the spaces of augmented reality and virtual reality for training and simulation purposes within medical, military, and professional environments as well as within the entertainment and gaming industries. Wearable haptic devices can also enhance day-to-day interactions, particularly for persons with clinically encumbered visual and auditory senses.

The present wearable haptic devices include a fluidic circuit encased in a wearable accessory or item of clothing. The fluidic circuit includes a fluidic capacitor, capable of storing fluid in the device, and a fluidic resistor, capable of slowing fluid flow through the device. The device can deliver high resolution information to the wearer based on embedded fluidic programming which causes fluid to inflate a fluidic capacitor, exerting pressure on the wearer. For this reason, a fluidic capacitor may also be called an inflatable cell. The designs of these wearable haptic devices enable tailorable control of spatial, temporal, and amplitude signals. They are shown, for example, to deliver spatiotemporal cues in four directions with an average user accuracy of 87%. These capabilities are successfully utilized in haptic navigation within real-world environments, such as open fields and city streets.

Though fluidic control may be slower than electronic control, the response times may be tuned through simple subcomponents and low levels of complexity to be minimally impactful to the usability of the device. Moreover, fluidic response times may be leveraged to achieve desirably noticeable delays across actuators, creating targeted haptic cues. Furthermore, fluidic signals may be interfaced with some upstream electronic system to improve the performance and wearability of a wearable haptic device. Computers, gaming consoles, navigation systems, and many other systems with which we interact daily are electronic, and the present fluidic analog control may rely upon these electronic systems in real-world scenarios. This fluidic-to-electric transition is achievable at low costs with a wide availability of commercial components. The methods may also off-board high-level computation to the already non-wearable systems, allowing for the wearable haptic device to remain fully soft and unobtrusive to the user which is unlike many other haptic devices currently available.

FIGS. 1A-1C depict a plurality of embodiments of wearable haptic devices solely for the purposes of illustration. Many additional embodiments, not shown, may also be realized providing a wide range of wearables haptic devices. FIG. 1A depicts fluidic circuits 100 which can be part of a wearable haptic device. An inflatable cell 102 is disposed on a forearm, inflatable cell 112 is disposed on a wrist of a forearm, and further inflatable cells 110 are disposed on fingers. The inflatable cells, such as inflatable cells 102 and 112, disposed on a wrist or a forearm may be secured to the wrist or forearm using a wristband 104 that may be fastened, unfastened, tightened, and loosened as required. Fluid may be provided to the inflatable cells 102,112 via channels 106 and/or to the inflatable cells 110 deployed on the fingers via channels 108. The wearer may experience a haptic stimulation, such as an increased or decreased pressure on their wrist or forearm, when the fluidic circuit is activated, e.g., the inflatable cell 102 is inflated. The inflatable cell 102 disposed on a forearm may be used alone or in combination with the inflatable cell disposed on the wrist 112 and/or the inflatable cells 110 disposed on the fingers to provide additional haptic stimulation.

Fluidic circuits such as the ones shown in FIG. 1A can be integrated into an article of clothing including, though not limited to, gloves, hats, shirts, socks, wrist straps, and chest straps. By embedding a fluidic circuit into a wearable, the ease and range of use may be increased. For example, a glove 114 with an embedded fluidic circuit is depicted in FIG. 1B. Haptic stimulation may be applied to the forearm using an inflatable cell 116, to the hand using an inflatable cell 118, and/or fingers using inflatable cells 120. Other possible embodiments may include a hat or cap 122 shown in FIG. 1C. The arrangement of inflatable cells or pressure pads at an array of locations in the hat, such as an inflatable cell or pressure pad on the forehead 124, and one or more inflatable cells on the temple, such as inflatable cell 126. A directionality cue might be indicated, for example, by activating inflatable cell 126, located on the left temple, to indicate an instruction to make a left turn.

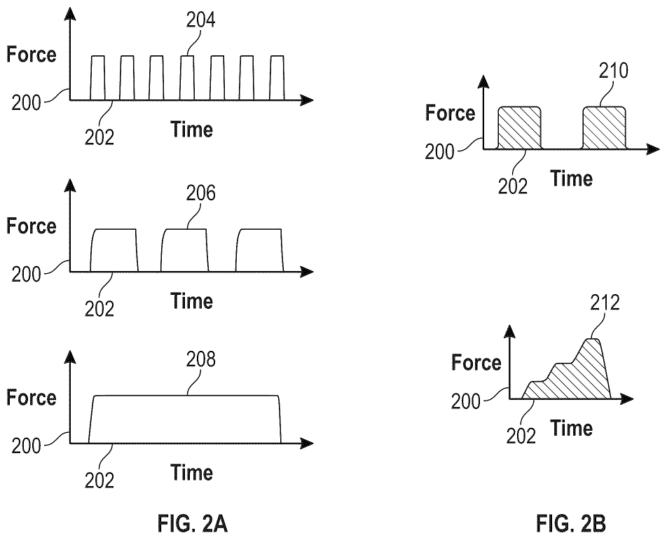

In addition to the spatial distribution of haptic stimulation, haptic stimulation may be varied temporally on a variety of timescales. For example, a rapid temporal variation of haptic stimulation may be experienced by the user as a vibration, while a pulse extending as a prolonged period of time may be experienced as a sustained pressure or force. Between these two extremes, a temporal fluctuation of intermediate rapidity may be experienced as a flutter. For example, in FIG. 2A a force is indicated on the vertical axis 200 and time is indicated on the horizontal axis 202. A vibration 204 may be experienced when the force varies rapidly in time, while a sustained force 208 may be experienced when the force is kept constant in time, and a flutter 206 may be experienced when the force is varied more slowly than in 204 but more quickly than in 208. The time scale of interest and frequency thresholds between each effect are application specific. The temporal variation in haptic stimulation may be used to encode information or instructions.

Haptic stimulation from a fluidic circuit may be described as digital or analog based upon the nature of the force applied to the user. In a digital system, the applied stimulation may be considered to be either “on” (a large stimulation) or “off” (little or no stimulation), while in an analog system the magnitude of the applied stimulation may have significance. For example, the analog system may use, for example, a negligible, a low, an intermediate, an elevated, and a large force, or any combination of any force on a continuum to indicate different information or instructions. A digital and an analog system are contrasted in FIG. 2B where force is indicated on the vertical axis 200 and time is indicated on the horizontal axis 202. A force in a digital system 210 is characterized by amplitudes of only two values. In some embodiments, the force may be zero, corresponding to a fluid pressure at or near atmospheric pressure. Alternatively, a force in an analog system 212 is shown varying in time 202 and may attain multiple levels (not just a high and low, or on and off).

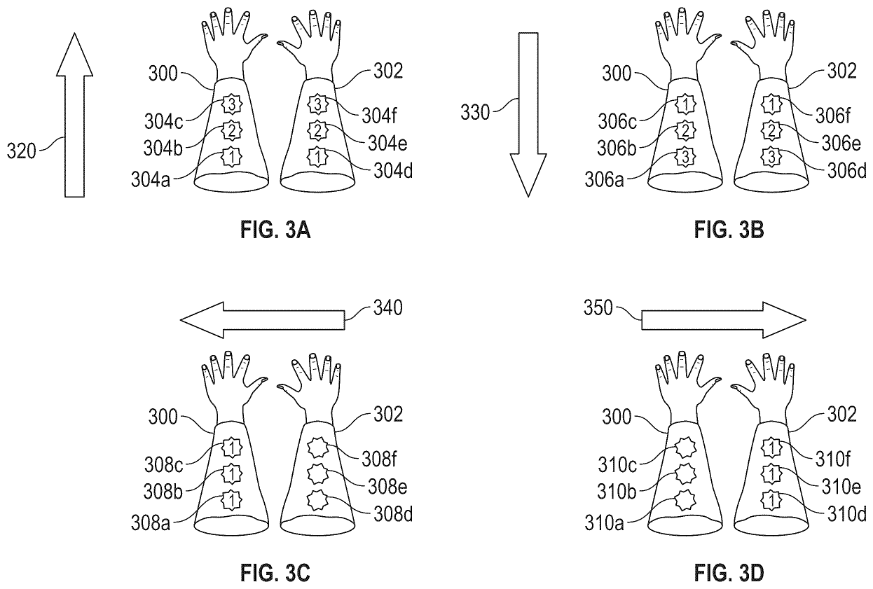

In addition to fluctuating haptic stimulation that vary solely in time, haptic stimulation devices may use variations in time and space. Examples of such space-time varying wearable haptic devices and how they may provide a spatiotemporal stimulus are shown in FIGS. 3A-3B.

FIG. 3A depicts a pair of wearable haptic textile stimulation sleeves, that may or may not be attached to other elements of a garment (such as a shirt). Each of the sleeves, 300 and 302, may include a plurality of inflatable cells, such as the inflatable cells 304a-c on the left sleeve 300, and inflatable cells 304d-f on the right sleeve (302). Each of the inflatable cells may be activated in sequence to indicate a specific instruction, such as to advance forward in the direction indicated by the arrow 320. For example, in some embodiments, inflatable cells 304a and 304d may be activated first, followed by inflatable cells 304b and 304e, followed by inflatable cells 304c and 304f, to indicate an instruction to move forward. In some embodiments, the inflatable cells 304a and 304d, and subsequently inflatable cells 304b and 304e, may remain inflated until the inflatable cells 304c and 304f have completed their activation (i.e., pressurized) while, in other embodiments, inflatable cells 304a and 304d may deactivate (i.e., release pressure) before, or at the same instant as, inflatable cells 304b and 304e are activated.

FIG. 3B depicts a space-time varying wearable haptic signal that may be used to indicate a requirement to retreat in the direction of the arrow 330. In this case, inflatable cells 306c and 306f may be activated first, followed by inflatable cells 306b and 306e, then inflatable cells 306a and 306d to indicate an instruction to reverse direction or retreat.

Similarly, FIG. 3C depicts an instruction to turn left in the direction of the arrow 340. In this case, only the inflatable cells 308a-c on the left sleeve 300 are activated while the inflatable cells 308d-f on the right sleeve 302 remain inactivated. Conversely, FIG. 3D depicts an instruction to turn right in the direction of the arrow 350. In this case, only the inflatable cells 310d-f on the right sleeve 302 are activated while the inflatable cells 310a-c on the left sleeve 300 remain inactivated.

In the wearable haptic textile stimulation sleeves, as well as some other embodiments, the wearable haptic device can at any given time provide 2^{N} discrete signals to the subject wearing the wearable haptic device, where N is the number of inflatable cells in the wearable haptic textile. Thus, for example, a wearable haptic textile comprising three inflatable cells will be able to provide 8 discrete signals at a given instant. Many additional signals may be produced by introducing time as a defining factor of each signal, i.e., each signal is a discrete combination of inflated and deflated inflatable cells at a given instant. When including temporal significance in each signal, a wearable haptic textile comprising three inflatable cells may be able to produce a plurality of signals much greater than the 8 which can be produced at a given time.

Different signals may be correlated to specific actions to be taken by the subject. As in the example above, the action may be a direction in which the subject must travel, such as forward, backward, left, or right. In other situations, the action may be a gesture required within a game, training simulation, or other augmented and/or virtual environment. Alternatively, a signal may be produced to provide a therapeutic effect, such as a tactile illusion of stroking through the sequential inflation and deflation of several inflatable cells. Other tactile illusions which may be produced could include the cutaneous rabbit illusion, the kappa effect, and the tau effect, among others.

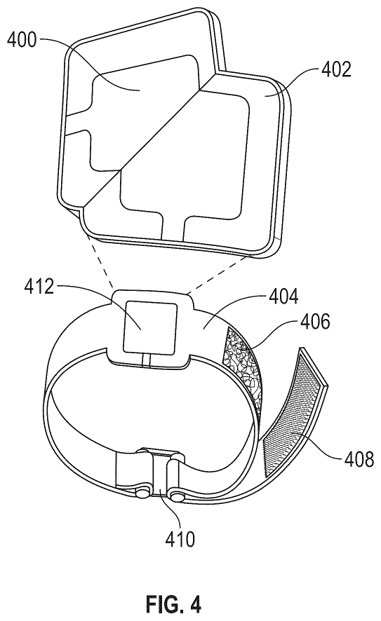

Another embodiment of a wearable haptic device, a haptic wristband, is shown in FIG. 4. The wristband is secured by hook fasteners 406 and loop fasteners 408, and it is easily adjustable using a slide bracket 410. In other embodiments, the haptic wristband may be secure by a Velcro strip, or a buckle (not shown), or other suitable means. The illustrated wristband is made of nylon taffeta 404 coated with thermoplastic polyurethane (TPU) 402 which creates a thermally bondable fabric, also called a heat-sealable textile (HST), although this is not intended to be limiting upon the scope of the invention. Under the application of heat and pressure, two layers of HST form a hermetic bond. The external geometry of each inflatable cell 412 created by the formation of a hermetic bond may be defined by the geometry of the bond. When fluid flows into the cell, causing the cell to inflate, the hermetic bond prevents, or inhibits, the cell from deflating.

As used herein, a “hermetic bond” refers to a bond that significantly inhibits or resists fluid flow or percolation through the beyond. Similarly, as used herein a hermetic fabric, material, or textile significantly inhibits or resists fluid flow or percolation through the fabric, material, or textile. In some embodiments, the inhibition or resistance to fluid flow or percolation may be so pronounced as to be effectively complete. In other embodiments fluid may still escape through the hermetic bond, but any consequent deflation is negligible at the time scales of interest for this embodiment. In some embodiments, the degree of effectiveness of the hermetic seal may be tuned to allow for a gradual deflation or other variation in deflation which would alter the haptic stimulation.

The internal geometry of the inflatable cell 412 is defined by adhesive-backed paper 400 which prevents the HST layers from bonding. Though the HST layers are shown here as two individual sheets, the same geometry could be produced using a single folded HST. More generally, any one portion of a material sheet could be bonded to any other portion of the same or a separate material sheet. Other embodiments may be manufactured using different films, sheet-based materials, or other thin and flexible materials such as polymers, or with a 3D printer wherein the 3D printer hot end can cause bonding to occur by application of heat and pressure or by extrusion of hot material, or both.

In one or more embodiments, the inflatable cell has an inner, i.e., internal, dimension, or width, measured perpendicularly from one inner edge of the cell to an opposite edge of 15 mm, 20 mm, 25 mm, or 30 mm. Changes to the cell geometry vary the resulting haptic stimulation, providing another tuning parameter. The 25-mm inflatable cell was found to exert an output force of 0-9.8 N across input pressures of 0-1 bar, mirroring a desired range of 0-10 N for tactile cues. Furthermore, the outward expansion of the 25-mm inflatable cell from the wrist, measured orthogonally to the surface of the wrist, was found to be 6 mm, generating an unobtrusive profile. Due to these considerations, 25-mm by 25-mm inflatable cells may be favored for some embodiments. In other embodiments, any or all of the dimensions of the inflatable cells could be changed, e.g., the length could be 35 mm and the width could be 10 cm, and/or the shape of the inflatable cell could be changed, e.g., a triangular inflatable cell could be fabricated.

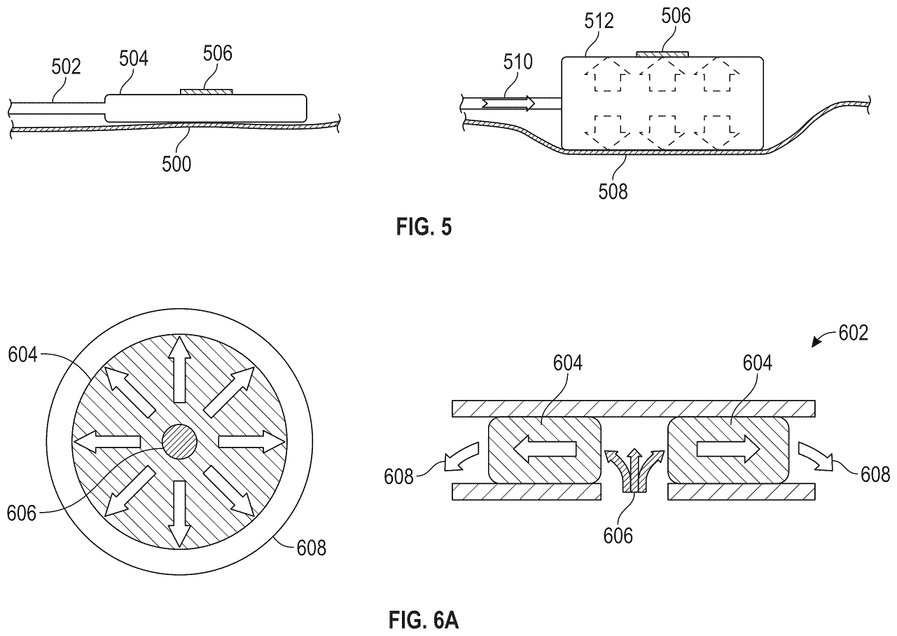

The haptic stimulation provided by an activated inflatable cell is illustrated in FIG. 5. A side view of an inflatable cell before inflation 504 is depicted. The inflatable cell 504 is secured to the skin of the wearer 500 via a strap 506. A channel 502 connects the inflatable cell to a pressure source. When fluid flows through the channel 510, the fluid fills the inflatable cell, resulting in the inflation of the inflatable cell 512 and its outward expansion. The outward expansion exerts pressure, i.e., haptic stimulation, on the skin of the wearer, resulting in a small indentation in the skin of the wearer 508. The haptic stimulation used in most of the embodiments discussed is pneumatic pressure from CO₂. Other gases, such as air,, could also be used. Additionally, some embodiments may utilize one (or multiple)_liquids and hydraulic pressure rather than pneumatic pressure.

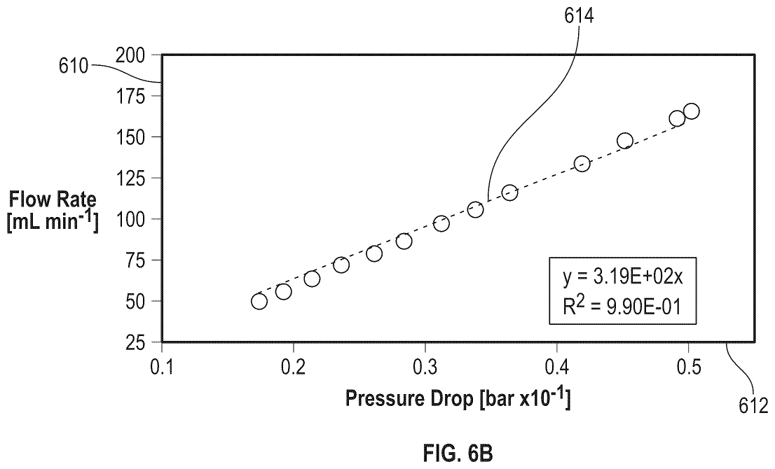

In addition to modulation in haptic stimulation which can be achieved with one or more inflatable cells, i.e., fluidic capacitors, haptic stimulation can be modulated using fluidic resistors. For example, FIG. 6A depicts an annular fluidic resistor. The fluidic resistor may be fabricated from open-cell polyurethane foam. In the top view of gas flow through a fluidic resistor 604, a pressure input 606 is shown coming from the center of the fluidic resistor 604 and traveling in the radial direction, causing a pressure output at the outside of the fluidic resistor 608. In the side view of gas flow through a fluidic resistor 602, a pressure input 606 is shown coming from the center of the fluidic resistor 604 and traveling outward, causing a pressure output at the outside of the fluidic resistor 608. Alternatively, the pressure input could come from outside of the fluidic resistor with a corresponding pressure output from the center of the fluidic resistor. The size, shape, and material of the fluidic resistor can be changed to tune the amount of impedance it causes.

The performance of one embodiment of a fluidic resistor, an annular foam resistor of 22-mm outer diameter and 3-mm inner diameter, is shown in FIG. 6B. The annular foam resistor was fabricated from 1.6 mm thick open-cell polyurethane foam which was found to impede fluid flow in the radial direction due to its microporous structure. A flow rate is indicated on the vertical axis 610 and a pressure drop is indicated on the horizontal axis 612. The fluidic resistance 614 was found to be 3.19×10³ mL min⁻¹ bar⁻¹. The foam was found to be mechanically and fluidically robust, yet it was soft and compliant. Furthermore, it retained a low profile, making it well-suited for integration into two-dimensional, textile-based devices.

The preceding embodiment of the structure and performance of a fluidic resistor is provided by way of illustration only and should not be interpreted as limiting the scope of the invention in anyway. In other embodiments, a fluidic resistor could be made in many other ways or from many other materials including, but not limited to, a permeable plug or a constricting channel. By way of another non-limiting example, in some embodiments a fluidic resistor may be constructed from a slim tube of non-permeable material formed into a coiled or serpentine channel.

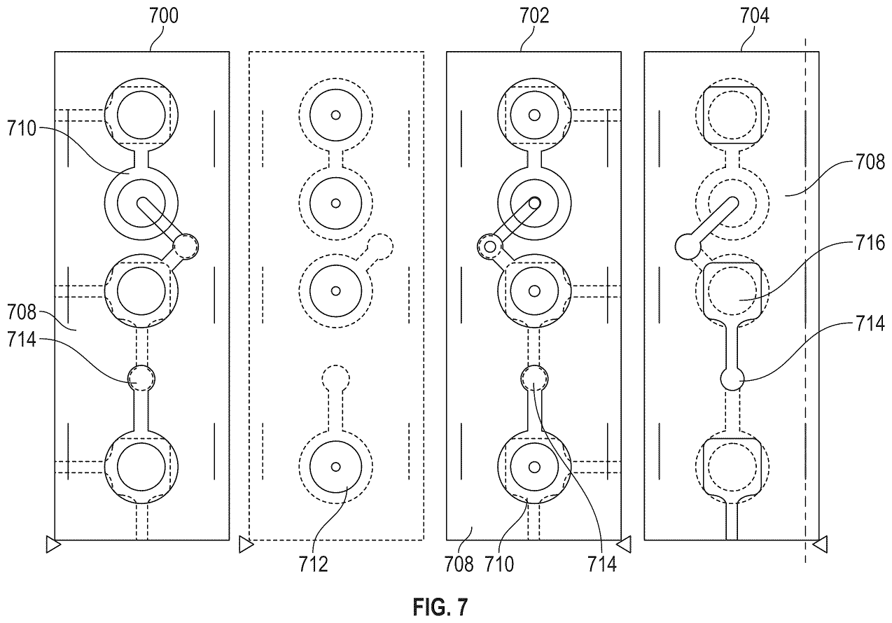

In one or more embodiments a plurality of fluidic capacitors and fluidic resistors may be used in a haptic stimulation device. For example, the layers of a haptic stimulation device with three fluidic capacitors 716 and four fluidic resistors 712 are depicted in FIG. 7. Each of the fluidic capacitors, such as fluidic capacitor 716, may be an independently inflatable cell, such as inflatable cell 412. Each of the fluidic resistors 712, for example, may be a fluidic resistor 604, such as a foam fluidic resistor. The first layer 700, second layer 702, and third layer 704 may be formed from HSTs cut into rectangles with the TPU-coating side facing up 708. Adhesive packed paper may be cut to define channels 710 and inflatable cells 716. When the device is functioning, fluid may pass through the nodes 714 in the channels. After cutting the three textile layers and aligning them, the annular foam resistors 712 may be manually placed between the first and second layer. The thickness of the adhered paper may aid any misalignment of the foam resistors during thermal bonding. Next, the three HST layers may be thermally bonded together with the resistors thermally bonded between the layers, preventing fluid from flowing through the top or bottom surfaces.

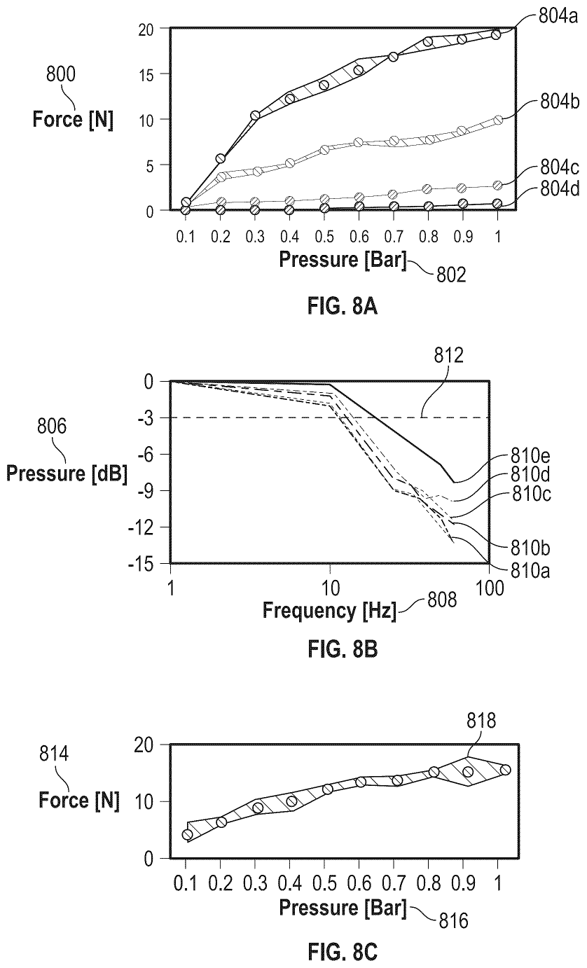

To gain additional insight into the effect of inflatable cell size on haptic stimulation, characterization tests were performed on haptic wristbands of various equal-width sides: 15 mm, 20 mm, 25 mm, and 30 mm. A pneumatic pressure source inflated each inflatable cell from 0 to 1 bar at increments of 0.1 bar. This pressure range is typical for soft robotic devices and is achievable by compressors and other sources of pressurized air, including but not limited to a wearable pneumatic energy harvesting system. In FIG. 8A the pressure input into an inflatable cell is plotted on the horizontal axis 802 and the resulting normal force exerted by the inflatable cell on the skin of the wearer is plotted on the vertical axis 800. The force as a function of pressure is plotted for the 30 mm inflatable cell 804a, 25 mm inflatable cell 804b, 20 mm inflatable cell 804c, and 15 mm inflatable cell 804d. The minimum and maximum steady-state forces of three trials is shown as the shaded regions. The four inflatable cells and, consequently, the four haptic wristbands had positively correlated force responses to input pressure and inflatable cell width. The largest cell (30 mm in width) demonstrated the largest forces (0-19 N), whereas the smallest cell (15 mm in width) produced the smallest forces (0-0.65 N).

A dynamic characterization was also performed on wristbands of the same four inflatable cell sizes to determine their bandwidths. FIG. 8B shows changes in the force that the inflatable cells apply when excited at different frequencies. The attenuation relative to the static steady-state force observed in FIG. 8A was measured for a range of frequencies. The attenuation of pressure is plotted on the vertical axis 806 and the frequency of excitation is plotted on the horizontal axis 808. The cutoff frequency (i.e., the baseband bandwidth) 812 was defined as −3 dB. Results are shown for the 30 mm inflatable cell 810a, 25 mm inflatable cell 810b, 20 mm inflatable cell 810c, 15 mm inflatable cell 810d, and a 0 mm inflatable cell 810e. The 0 mm inflatable cell, i.e., no wristband, was used as a control measurement.

Previous research has demonstrated that point-force cues begin to feel like “flutter” when provided at frequencies on the order of 10 Hz, and flutter begins to feel like vibration when cues are delivered on the order of 100 Hz. Since all four inflatable cells surpassed 10 Hz before the cutoff frequency, all four inflatable cells can provide both point-force cues and flutter cues.

Variability in experimental procedure and manufacturing were quantified for haptic wristbands with 30 mm inflatable cells, chosen for the largest range of forces that represent the upper limit of expected tolerances in nominal values of force. In FIG. 8C the pressure input into a 30 mm inflatable cell is plotted on the horizontal axis 816 and the resulting normal force exerted by the 30 mm inflatable cell on the skin of the wearer is plotted on the vertical axis 814. Each wristband was tested three times, resulting in nine trials per interval of pressure. The average value for each pressure level is plotted 818. The minimum and maximum steady-state forces from the averaged trials are shown as the shaded region. The average difference in force between the trials was determined to be 16%, indicating sufficient reliability the experimental and manufacturing methods.

The preceding embodiment of the structure and performance of a fluidic capacitor is provided by way of illustration only and should not be interpreted as limiting the scope of the invention in anyway.

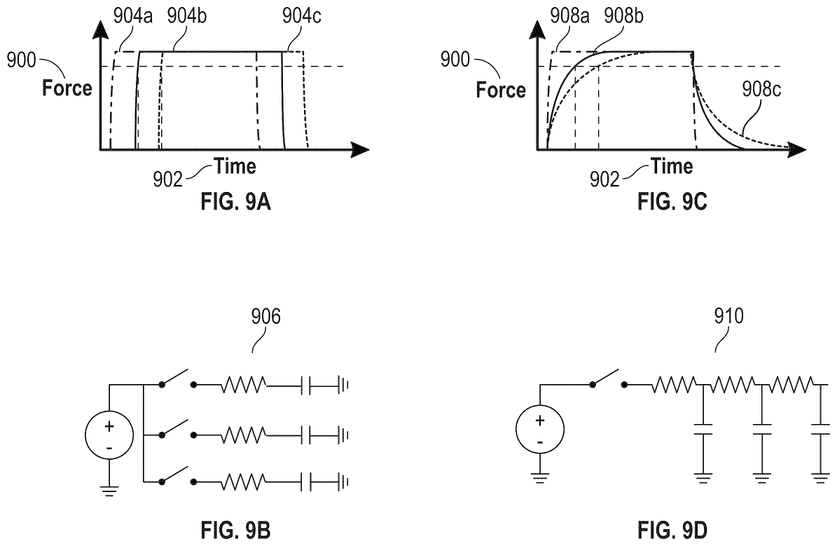

Having discussed the signal control that can come from fluidic programming, i.e., engineered fluidic capacitors and fluidic resistors, it is useful to consider how this differs from the more traditional valve-based programming. Consider a set of three inflatable cells. In valve-based programming, each inflatable cell would be associated with a separate valve. FIG. 9A shows the response of each inflatable cell upon activation, i.e., inflation, in valve-based programming. The force that is exerted by an inflatable cell is plotted on the vertical axis 900 and the time at which an inflatable cell is activated is plotted on the horizontal axis 902. When the first inflatable cell is activated by the first valve, a resulting force 904a appears. It then quickly dissipates when the pressure is released. The same process is repeated for the second inflatable cell when it is activated by the second valve, resulting in a second force 904b, then the third inflatable cell when it is activated by the third valve, resulting in a third force 904c. The inflatable cells function independently. The pneumatic circuit 906 for this example of valve-based programming is plotted in FIG. 9B.

In fluidic programming, each inflatable cell could be associated with the same valve, a master valve, which reduces the electronic components needed for the circuit. FIG. 9C shows an example of the response of each inflatable cell upon activation, i.e., inflation, in a fluidic circuit. The force that is exerted by an inflatable cell is plotted on the vertical axis 900 and the time at which an inflatable cell is activated is plotted on the horizontal axis 902. When the master valve is open, all three inflatable cells are activated. The first inflatable cell has the same resulting force 908a as seen in the valve-based programming example. The second inflatable cell has a force 908b which builds gradually and dissipates more slowly. This trend continues with the third inflatable cell which has a force 908c which builds still more gradually and dissipates at an even slower rate. The pneumatic circuit 910 for this example of fluidic programming is plotted in FIG. 9D. While this example shows each inflatable cell fluidically connected in series to a master valve, it would also be possible to fluidically connect inflatable cells in parallel and/or use a plurality of valves arranged in a manifold.

The preceding example of the structure and performance of a fluidic circuits is provided by way of illustration only and should not be interpreted as limiting the scope of the invention in anyway.

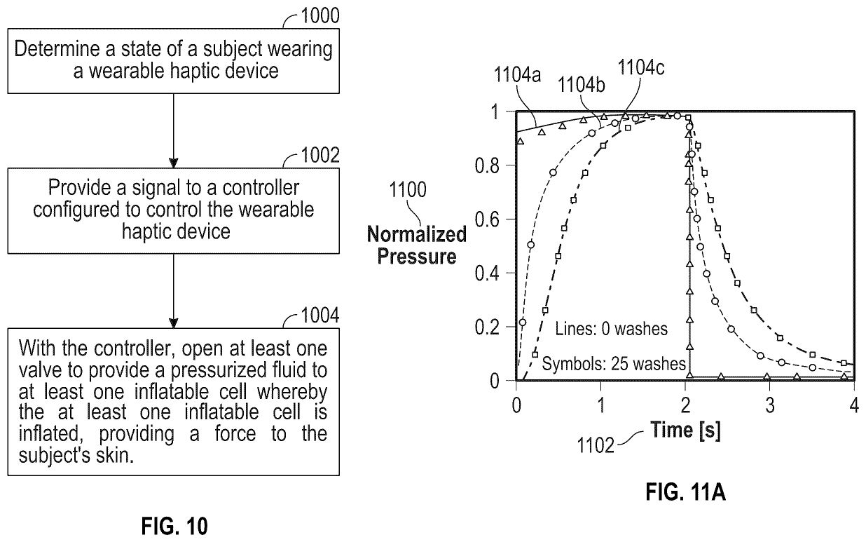

A fluidic circuit within a wearable haptic device can be made more advanced by including a component that either monitors a state, such as location, speed, or heart rate, of the wearer, or interfaces with a device (such as a cell phone) that monitors a state, such as location, speed, or heart rate, of the wearer. The fluidic circuit could be programmed to respond in a specific way to a specific state of the wearer. The haptic stimulation provided in these cases could be defined as “haptic feedback”. A method by which a wearable haptic device could provide haptic feedback is shown in FIG. 10. First, the state of the wearer would be determined by the wearable haptic device 1000. Next, the state of the wearer would be sent as a signal to a controller configured to control the wearable haptic device 1002. Finally, the controller would switch on at least one valve to provide a pressurized fluid to at least one inflatable cell, causing it to inflate which provides an out-of-plane force to the wearer's skin 1004.

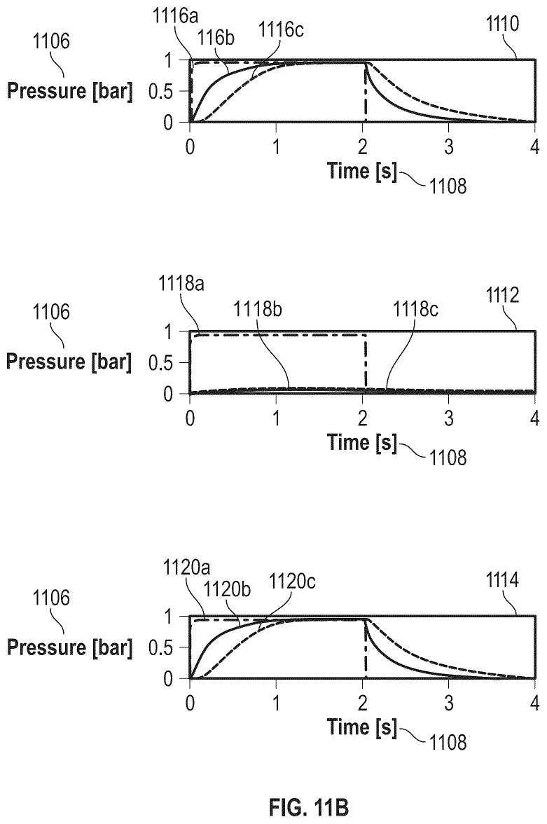

An advantage of the wearable haptic device designs described above is their washability and repairability. For example, FIG. 11A shows the performance of a wearable haptic sleeve before and after washing. To perform the tests, the ports of the wearable haptic sleeve were first sealed with Luer lock connectors. The wearable haptic sleeve was then secured in a laundry bag and placed in a washing machine with approximately 10 other garments. The washing machine was loaded with laundry detergent and set to a delicate cycle with the coldest temperature, lowest soil level, and one rinse cycle. The normalized pressure for each inflatable cell within the wearable haptic sleeve was recorded prior to washing and after twenty-five washes. The wearable haptic sleeve was left to dry before a pressure measurement was taken. Normalized pressure is plotted on the vertical axis 1100 and the timing of the response is plotted on the horizontal axis 1102 of FIG. 11A. The responses of the first inflatable cell 1104a, the second inflatable cell 1104b, and the third inflatable cell 1104c are plotted. Lines are used to denote the response of each inflatable cell before washing and symbols are used to denote the response of each inflatable cell after twenty-five washes. The device is shown to remain fully functional after twenty-five washes.

FIG. 11B shows the repairability of a wearable haptic sleeve. To test repairability, the second cell of a wearable haptic sleeve was cut open by a knife then repaired by ironing a patch of HST over the cut. The response of the inflatable cells before the cut are shown in 1110, the response of the inflatable cells after the cut are shown in 1112, and the response of the inflatable cells after the repair are shown in 1114. Pressure is plotted on the vertical axis 1106 and time is plotted on the horizontal axis 1108. In the pre-cut plot 1110, the responses of the first inflatable cell 1116a, the second inflatable cell 116b, and the third inflatable cell 1116c are shown. This provides a baseline for comparison. In the post-cut plot 1112, the response of the first inflatable cell 1118a appears normally, but the responses of the second inflatable cell 1118b and the third inflatable cell 1118c are essentially zero. This result is expected since the pressurized fluid would release through the cut in the second inflatable cell as it travels through the fluidic circuit. Finally, in the post-repair plot 1114, the response of all three inflatable cells 1120a-1120c is shown to return to normal, indicating the effectiveness of the repair. The preceding example of the structure, use and performance of a wearable haptic sleeve is provided by way of illustration only and should not be interpreted as limiting the scope of the invention in anyway.

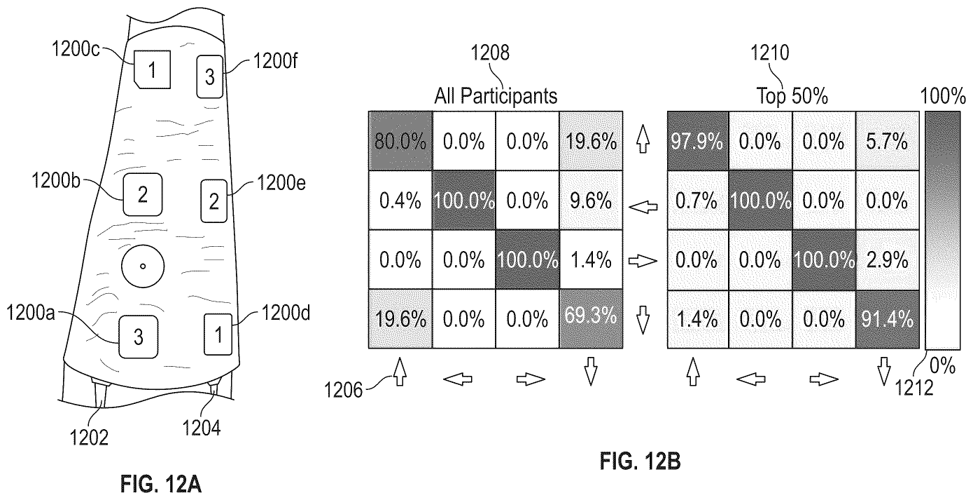

Since a wearable haptic device may comprise a plurality of inflatable cells, a multi-cell wearable haptic sleeve may be manufactured to have more than three inflatable cells or fewer than three inflatable cells. A six-cell wearable haptic sleeve for the forearm is pictured in FIG. 12A. This embodiment has two sets of three inflatable cells, programmed to deliver spatiotemporal cues in opposite directions; the pressure input on the left 1202 activates inflatable cell 1200c followed by inflatable cell 1200b then inflatable cell 1200a, whereas the pressure input on the right 1204 activates inflatable cell 1200d followed by inflatable cell 1200e then inflatable cell 1200f. Two of the six-cell wearable haptic sleeves can be used simultaneously to deliver four spatiotemporal cues to a wearer. Forward directions were indicated by the left and right arms having distally propagating inflation of the inflatable cells; backward directions were indicated similarly, but in the proximal direction. Left and right directions had both the distally and proximally propagating inflatable cells actuate on the sleeve worn by the corresponding arm.

The effectiveness of six-cell wearable haptic sleeves in conveying directional cues to a wearer was tested in a human-subject experiment with 14 participants (6 female, 12 righthanded, aged 20-27 years, with an average age of 23 years). Each participant received haptic cues for four different directions and relayed the perceived haptic cues to the experimenter. An opaque sheet covered the participant's arms during testing to prevent visual feedback. The results from human subjects are shown in FIG. 12B. The left grid 1208 shows the responses of all the participants and the right grid 1210 shows the responses of the top half of participants. The directional cues relayed to the participants are shown as arrows between the left and right grids. The haptic cues perceived by the participants are indicated by arrows 1206 below the grids. Perfect accuracy in correctly perceiving all of the haptic cues relayed corresponds to the main diagonal (top left to bottom right) of each grid.

The participant responses were recorded as percentages in the relevant square of the grid, e.g., 100% of participants perceived a left haptic cue when given a left haptic cue. A scale 1212 was used to indicate the level of accuracy in participant responses. A darker color corresponds to higher accuracy. The participants overall scored an average accuracy of 87.3%. However, when non-responders were excluded and the accuracy for participants above the median was analyzed, the adjusted average accuracy jumped to 97%. The preceding example of the structure, use, and performance of a wearable haptic sleeve is provided by way of illustration only and should not be interpreted as limiting the scope of the invention in anyway.

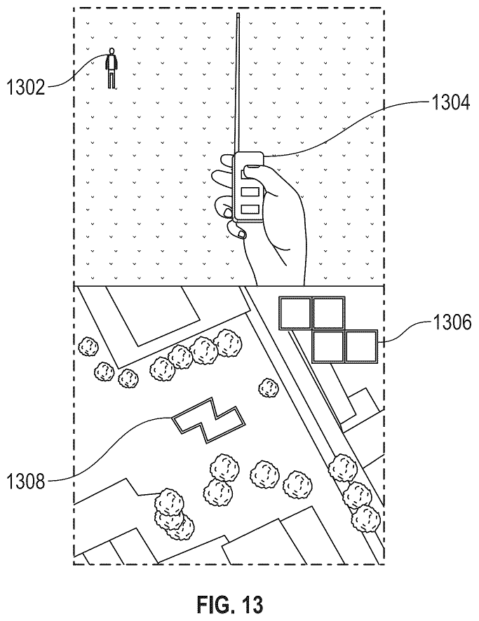

Six-cell wearable haptic sleeves can provide haptic feedback for navigation by connecting to the wearer's geographical location, determined either automatically or via an external source. FIG. 13 shows an example of a test participant 1302 navigating through an open field using haptic feedback from a portable version of the six-cell wearable haptic sleeves. A controller 1304 was configured to control the fluidic circuits of the six-cell wearable haptic sleeves. The controller received a signal based on the geographical state of the subject. A signal was then sent from the controller to one or more valves controlling the fluid flow in the fluidic circuit of the six-cell wearable haptic sleeves.

Based on the haptic cue received, the test participant would then perceive a directional cue and walk in that direction. Left, right, and forward cues indicated directionality and a single backward cue indicated stopping or “arriving at destination.” Such steps were repeated iteratively to guide a subject in navigating to one or more waypoints. GPS data was used to track the path of each participant to determine whether they accurately interpreted the haptic directions. One participant was given haptic cues to walk a path outlining a tetromino 1306, a shape made from four unit squares orthogonally connected. Tetrominoes represent the 90-degree corners present in typical navigational instructions in the real world yet allow for a more difficult mode of unstructured testing without preexisting surface streets for reference and, consequently, demonstrate applicability beyond the specific use case of navigation alone. The path the participant walked 1308 is shown to match the path assigned 1306, indicating that the participant responded to each haptic cue with 100% accuracy. This accuracy was found to be repeatable for other tetrominoes.

In this example of haptic navigation, the stopping condition was met when a participant arrived at a pre-determined destination. In other embodiments, the stopping condition could be met in a myriad of other ways, for example, when a timer ends, when a traffic light turns red, or when the participant's heart rate reaches a certain level. The preceding example of haptic navigation is provided by way of illustration only and should not be interpreted as limiting the scope of the invention in anyway.

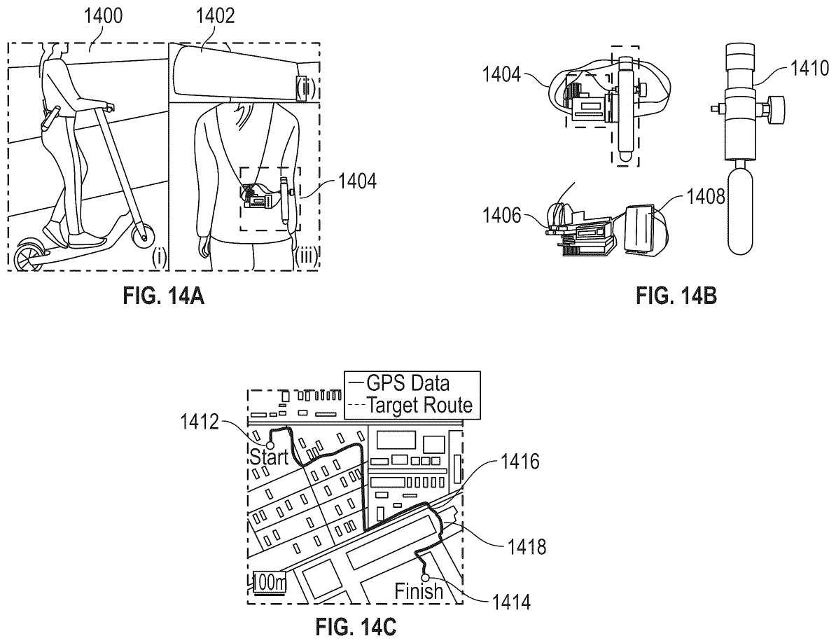

The portable six-cell wearable haptic sleeves were also used for navigation through a city. A test participant 1400, shown in FIG. 14A, would either walk or operate a scooter along a route. Two six-cell wearable haptic sleeves such as 1402 were integrated into a shirt. Four tubes routed through the shirt, connecting the pneumatic inputs to miniature solenoid valves soldered to a circuit board. The circuit board was mounted alongside other auxiliary components on an elastic textile belt 1404, and hook-and-loop fasteners were used to secure components onto the belt. FIG. 14B shows the belt and components in more detail. The miniature solenoid valves 1406 were powered by a 9-V battery 1408.

A 4-channel wireless remote was configured to send 433-MHz signals corresponding to the four directions which were delivered to the user by the portable supply of CO₂ 1410. The controller could run continuously for over 40 hours while providing one cue per minute based on the current draw of the components and the capacity of the battery. The experimenter provided haptic cues to direct the user in waypoint-based navigation for walking 1 km in one test and operating a scooter for 1 km in another test. FIG. 14C shows the intended starting point 1412 and the intended ending point 1414. The location of a participant was tracked using a global positioning system (GPS) receiver installed on the participant's mobile phone. Haptic cues were transmitted through the wireless remote from afar, and the user was unaware of the intended route or destination in any of the untethered, i.e., field and city navigation, tests.

The user interpreted the cues with 100% accuracy, even while operating the electric scooter over vibration-inducing paved bricks, concrete sidewalks, and graveled paths; the route targeted with haptic cues 1416 and the route taken by the participant 1418 are indistinguishable from each other. Vibrations felt from travel could cause issues with the typical vibrotactile signals seen in commercial wearable haptic devices due to neural adaptation leading to vibrotactile desensitization, but these negative effects were not seen in any of the untethered navigational experiments performed using the six-cell wearable haptic sleeves. These navigational experiments using one embodiment of the invention show that the spatiotemporal force cues applied using wearable haptic devices are well-suited for untethered navigation.

The wearable haptic devices described herein improve upon device wearability by implementing fluidic programming to reduce off-board electronic components. The devices are shown to be effective at delivering spatiotemporal cues within devices fabricated from comfortable and lightweight form factors. Such devices may be easily integrated into wearables that blend in with everyday clothing. Additionally, utilizing material intelligence, greater complexity in haptic stimulation may be achieved without increasing the hardware requirements. Finally, the wearable haptic devices are shown to be washable and repairable, further increasing their utility.

The preceding example of the structure, use, and performance of a wearable haptic sleeve is provided by way of illustration only and should not be interpreted as limiting the scope of the invention in anyway.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A wearable haptic device comprising:
a fluidic circuit comprising:
at least one fluidic capacitor, and
at least one channel fluidically connected to the at least one fluidic capacitor;
wherein each of the at least one fluidic capacitor comprises an inflatable cell formed from a portion of a first material sheet bonded to a portion of a second material sheet to form a hermetic bond, and
wherein each of the at least one channel is configured to convey a pressurized fluid to the at least one fluidic capacitor.

2. The wearable haptic device according to claim 1, further comprising a fluidic resistor, fluidically connected to the inflatable cell via the channel.

3. The wearable haptic device according to claim 2, wherein the fluidic capacitor and the fluidic resistor are configured to form a fluidic circuit.

4. The wearable haptic device according to claim 3, wherein the fluidic circuit is configured to apply a spatiotemporal stimulus to a wearer.

5. The wearable haptic device according to claim 1, further comprising a sleeve for securing the inflatable cell to a subject.

6. The wearable haptic device according to claim 1, wherein the at least one fluidic capacitor comprises a plurality of fluidic capacitors fluidically connected in parallel.

7. The wearable haptic device according to claim 2, wherein the at least one fluidic capacitor comprises a plurality of fluidic capacitors fluidically connected in series.

8. The wearable haptic material according to claim 1, wherein each of the at least one fluidic capacitor further comprises a thermoplastic coating.

9. The wearable haptic material according to claim 2, wherein the fluidic resistor comprises a permeable structure.

10. A method of providing spatiotemporal cues, the method comprising, iteratively, until a stopping condition is met:
determining a state of a subject wearing a wearable haptic device;
providing a signal to a controller configured to control the wearable haptic device; and
with the controller, switching on at least one valve to provide a pressurized fluid to at least one inflatable cell whereby the at least one inflatable cell is inflated, providing a force to a skin surface of the subject.

11. The method according to claim 10, wherein the state is a geographical position of the subject.

12. The method according to claim 10, wherein the stopping condition comprises a proximity of the subject to a waypoint.

13. A system for providing spatiotemporal cues, comprising:
a wearable haptic device comprising a fluidic circuit having:
at least one fluidic capacitor, wherein each of the at least one fluidic capacitor comprises an inflatable cell formed from a portion of a first material sheet bonded to a portion of a second material sheet to form a hermetic bond,
at least one channel fluidically connected to the fluidic capacitor, each of the at least one channel is configured to convey a pressurized fluid to the at least one fluidic capacitor,
a master valve, fluidically connected to the at least one channel, and
a fluid source fluidically connected to the at least one fluidic capacitor via the at least one channel; and
a controller configured to send and receive signals to deliver a pressurized fluid to the at least one fluidic capacitor.

14. The system according to claim 13, wherein the wearable haptic device comprises a multi-cell sleeve.

15. The system according to claim 13, further comprising at least one fluidic resistor fluidically connected to at least one inflatable cell.

16. The system according to claim 13, wherein the master valve comprises a plurality of valves.

17. The system according to claim 16, wherein each valve of the plurality is fluidically connected to a single inflatable cell.

18. The system according to claim 13, wherein the master valve is fluidically connected to a plurality of inflatable cells.

19. The system according to claim 18, wherein the plurality of inflatable cells is fluidically connected in parallel.

20. The system according to claim 18, wherein the plurality of inflatable cells is fluidically connected in series.
